(19) United States
(12) Patent Application Publication
(10) Pub. No.: US 2026/0229993 A1
(43) Pub. Date: Aug. 6, 2026

(54) HIGHER EFFICIENCY, LONGER HOLDUP TIME DC INPUT FRONT END POWER SUPPLY

(71) Applicant: Cisco Technology, Inc., San Jose, CA (US)

(72) Inventors: Xiqun Zhu, Sunnyvale, CA (US); Alpesh Umakant Bhobe, Sunnyvale, CA (US)

(21) Appl. No.: 19/172,834

(22) Filed: Apr. 8, 2025

Related U.S. Application Data
(60) Provisional application No. 63/751,895, filed on Jan. 31, 2025.

(51) Int. Cl. H02M 3/07

(52) U.S. Cl. CPC H02M 3/07

(57) ABSTRACT

A power supply device is provided that an input current circuit and an energy holdup circuit. The input current circuit comprises an input for receiving input power, and an output for providing power to a powered device. The energy holdup circuit is connected to the input current circuit and includes one or more capacitors for storing energy. The energy holdup circuit is configured to couple energy stored in the one or more capacitors to the output when there is a loss of the input power, and to not direct current through the one or more capacitors when the input receives the input power.

### CROSS REFERENCE TO RELATED APPLICATION

This application claims priority to U.S. Provisional Application No. 63/751,895, filed Jan. 31, 2025, the entirety of which is incorporated herein by reference.

### TECHNICAL FIELD

The present disclosure relates to power supply units.

### BACKGROUND

In today's power supply units, input current unnecessarily passes through energy holdup capacitors. The energy passing through the capacitors causes efficiency loss due to the Effective Series Resistance (ESR) of the energy holdup capacitors, which increases power supply temperatures, reduces capacitor life, and requires capacitor voltage derating. In addition, the initial charging current of a large capacitor leads to high inrush current. As a result, inrush current limiting circuits and surrounding components are required, which further increases front end direct current (DC) power supply component counts, size, and cost and reduces DC power supply unit (PSU) efficiency.

### BRIEF DESCRIPTION OF THE DRAWINGS

FIG. 1 is a diagram illustrating a power supply unit with an input current circuit and an energy holdup circuit that includes an energy storing capacitor, according to an example embodiment.

FIG. 2A is a diagram illustrating an example in which an input DC loss detector uses a comparator to determine whether input power has been lost or interrupted, according to an example embodiment.

FIG. 2B is a diagram illustrating an example in which an input DC loss detector uses a circuit that comprises an analog to digital converter (ADC) and a microcontroller to determine input power has been lost or interrupted, according to an example embodiment.

FIG. 3 illustrates a circuit in which capacitors located in an input current circuit are replaced by smaller capacitors located in an energy holdup circuit, according to an example embodiment.

FIG. 4 illustrates results of measurements performed before and after replacing bulk capacitors in an input current circuit with smaller bulk capacitors in an energy holdup circuit connected to the input current circuit, according to an example embodiment.

FIG. 5 is a flow chart illustrating a method of transmitting energy stored in capacitors of an energy holdup circuit to an output when there is a loss of the input power, according to an example embodiment.

### DETAILED DESCRIPTION

### Overview

In one embodiment, a power supply device is provided. The power supply device includes an input current circuit that includes an input for receiving input power, and an output for providing power to a powered device. The power supply device further includes an energy holdup circuit connected to the input current circuit. The energy holdup circuit includes one or more capacitors for storing energy. The energy holdup circuit is configured to couple energy stored in the one or more capacitors to the output when there is a loss of the input power, and to not direct current through the one or more capacitors when the input receives the input power.

In another embodiment a method is provided. The method includes receiving, at an input of an input current circuit of a power supply unit, input power. The method further includes providing, by an output of the input current circuit, power to a powered device. The method additionally includes transmitting, by an energy holdup circuit connected to the input current circuit, energy stored in one or more capacitors of the energy holdup circuit to the output when there is a loss of the input power. Current does not flow through the one or more capacitors when the input receives the input power.

In yet another embodiment, a device is provided. The device includes an energy holdup circuit connected to an input current circuit. The energy holdup circuit includes one or more capacitors configured to store energy. Current does not flow through the one or more capacitors when the input current circuit receives input power. The energy holdup circuit further includes an isolated direct current (DC)-to-DC converter configured to couple energy stored in the one or more capacitors to an output of the input current circuit when there is a loss of the input power.

### EXAMPLE EMBODIMENTS

In today's power supply units, input current unnecessarily passes through energy holdup capacitors during normal operation of the power supply units, which causes an efficiency loss of the input due to the Effective Series Resistance (ESR) of the energy holdup capacitors. Unnecessarily passing input current through energy holdup capacitors increases power supply temperatures, which reduces capacitor life spans, and requires voltage derating, which in turn decreases the holdup time of the capacitors. Since the holdup energy is needed only when the input power is interrupted or lost, which happens infrequently, the energy holdup capacitors do not need to remain in the input current loop circuit.

Presented herein is a power supply device for providing power to a powered device that includes an energy holdup circuit that is connected to a main input current circuit. The energy holdup circuit includes energy holding capacitors configured to store energy and an input DC loss detector to detect when input power to the input current circuit is lost. When there is no loss of power in the main input current circuit, current does not flow through the energy holdup capacitors in the energy holdup circuit. When the DC loss detector detects a loss of power, energy stored in the energy holding capacitors is coupled to an output of the main input current circuit to provide power to the powered device.

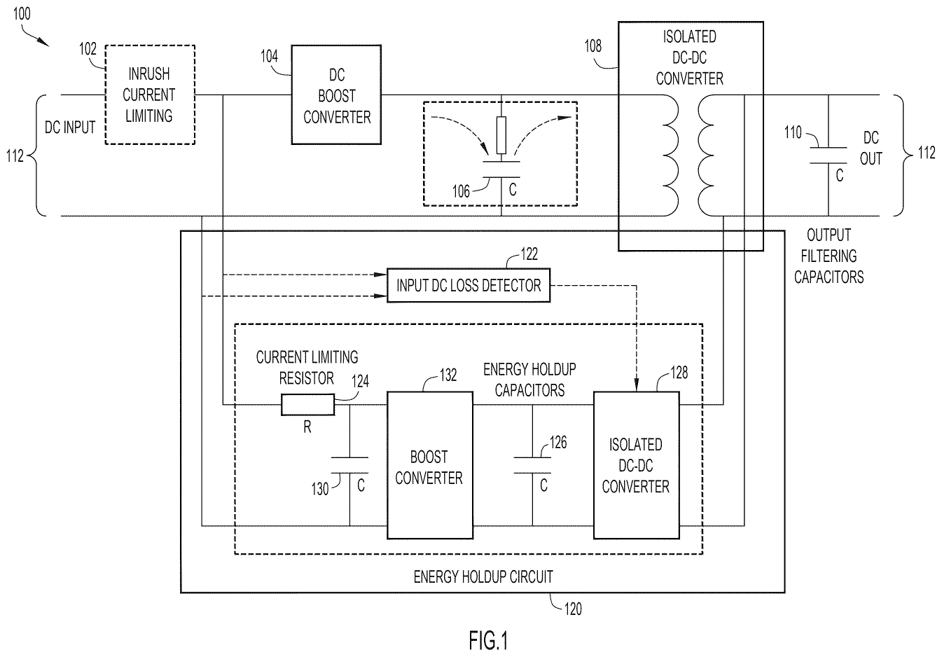

Reference is first made to FIG. 1. FIG. 1 is a diagram illustrating a power supply device 100. Power supply device 100 includes a main input current circuit 112 and an energy holdup circuit 120 that is connected to the main input current circuit 112. Some components of the main input current circuit 112 and energy holdup circuit 120 have been omitted for brevity. In addition, components of main input current circuit 112 that are in dashed boxes may be omitted from main input current circuit 112 when energy holdup circuit 120 is being implemented.

In a typical power supply device that is powering a powered device, a main input current circuit 112 may include an inrush current limiting circuit 102, a DC boost converter 104, a capacitor 106, an isolated DC-to-DC converter 108, and an output filtering capacitor 110. The main input current circuit 112 receives a DC input and provides a DC output for powering a load, such as a powered device. Although only one capacitor 106 is shown in FIG. 1 and described with respect to FIG. 1, capacitor 106 may be a bank of capacitors that includes more than one capacitor. In this system, the input current flows through capacitor 106 in main input current circuit 112. The input voltage received at main input current circuit 112 may vary across a large range (e.g., from 40V to 72V). When the input voltage is received, DC boost converter 104 boosts the voltage to a common voltage (e.g., 78V) that is higher than the input voltage range. Keeping the voltage steady ensures that isolated DC-to-DC converter 108 is able to work in the best efficiency region.

The configuration of main input current circuit 112 illustrated in FIG. 1 has several issues. The first issue is the need for inrush current limiting circuit 102. In this system, the initial charging current of a large capacitor, such as capacitor 106, leads to high inrush current. To decrease the high inrush current, typical power supply devices require inrush current limiting circuits, such as inrush current limiting circuit 102, and surrounding components. Adding the inrush current limiting circuit 102 and surrounding components to main input current circuit 112 increases the front-end DC power supply component counts, size, and cost while also reducing efficiency.

A second issue is the Effective Series Resistance (ESR) of the capacitor 106. Because the capacitor 106 is continuously charging and discharging during operation (i.e., because current is consistently running through capacitor 106), there is power loss across the capacitor 106, which reduces efficiency. As discussed above, the current passing through capacitor 106 additionally increases a temperature of capacitor 106 and reduces a lifespan of capacitor 106.

A third issue is lower holdup energy stored by capacitor 106 due to necessarily voltage derating of capacitor 106. During a time of loss of power, the energy stored by capacitor 106 is provided to a downstream circuit/powered device to provide continuous energy or power to the powered device for a period of time. The holdup energy is important because the downstream circuit needs to be shut down in a controlled manner so that the operation of the powered device is recoverable after the DC input power is restored. When a loss of input power occurs, the energy stored in capacitor 106 is used for a period of time (e.g., 10-20 milliseconds) to provide power to the powered device until the input power is restored.

While capacitor 106 is operating and current is passing through capacitor 106, the voltage across capacitor 106 may have ripples or variations. Each capacitor has a voltage rating indicating the maximum safe potential difference that can be applied between the positive and negative capacitor plates. Because the varying voltage may spike above the voltage rating of capacitor 106, capacitor 106 is derated (e.g., by 20%). For example, if capacitor 106 has a 100V rating and capacitor 106 is derated by 20%, capacitor 106 may be used up to 80V to ensure that the voltage across capacitor 106 will not exceed the rated voltage and to conserve the lifespan of the capacitor. The energy stored in a capacitor is proportional to the square of the voltage across the capacitor. Therefore, by derating capacitor 106, the energy stored by capacitor 106 is lower than a maximum amount of energy that can be stored by the capacitor and the holdup time is decreased. To hold the same amount of energy as a non-derated capacitor, a larger derated capacitor must be used, which is more expensive and takes up more space.

Techniques described herein solve the above issues by moving the capacitor from the main input current circuit 112 to the energy holdup circuit 120. When the capacitor is located in the energy holdup circuit 120 and not in the main path of the input power, input current is not flowing through the capacitor. Because the capacitor is not constantly be charged and discharged, the ESR of the capacitor is reduced. In addition, because the current is not passing through the capacitor and there is not a large variation in voltage across the capacitor, voltage derating of the capacitor is not needed, which increases the amount of energy stored by the capacitor and increases the holdup time when power is lost. In addition, the capacitor may be slowly charged through a large resistor, which eliminates the need for inrush current limiting.

According to embodiments described herein, the capacitor 106 is removed from the main input current circuit 112 and capacitor 126 is placed in energy holdup circuit 120 to store energy for providing to the downstream circuit/powered device in the event of a power loss. Although only one capacitor 126 is illustrated in FIG. 1 and described with respect to FIG. 1, capacitor 126 may be a capacitor bank that includes more than one capacitor. In one embodiment, the capacitor bank may be a switched bank, and capacitors may be added to or removed from the switched bank based on a power requirement of the powered device. In another embodiment, the power supply device may be designed for requirements of a powered device. In this embodiment, the fixed number of capacitors and the rating of the capacitors may be determined based on uses or applications.

In the example illustrated in FIG. 1, energy holdup circuit 120 is connected to main input current circuit 112 and includes input DC loss detector 122, current limiting resistor 124, capacitor 126, isolated DC-to-DC converter 128, input filtering capacitor 130, and boost converter 132. Energy holdup circuit 120 may include additional elements that have not been included in FIG. 1 for the sake of brevity.

During normal operation of the power supply device 100 (i.e., when there is no loss of input power), capacitor 126 is charged slowly through large current limiting resistor 124. When the input power is first turned on, the loading systems/powered devices have not been fully started and do not need immediate hold up power. Even if input power is lost at this time, the large current limiting resistor 124 may be used to make the capacitor 126 charge current very slowly. As a result of the slow charging of capacitor 126, power supply device 100 does not experience an inrush current issue. Therefore, inrush current limiting circuit 102 may be removed from main input current circuit 112, which reduces the cost associated with power supply device 100. Input filtering capacitor 130 may be used to filter the DC input and provide a steady input voltage for the boost converter 132.

Because capacitor 126 is not located in the main input current circuit 112, and is instead located in energy holdup circuit 120, input current does not flow through capacitor 126. Therefore, the ESR associated with capacitor 126 is drastically lower than the ESR associated with capacitor 106. In addition, voltage derating is not required for capacitor 126. Therefore, capacitor 126 can store energy at 100% of the voltage rating for the capacitor. For example, if capacitor 126 is rated for 100V, capacitor 126 can store energy based on 100V. This increases the energy stored in capacitor 126 compared to energy stored in capacitor 106 (that required voltage derating) and increases holdup time for providing energy to a powered device in the event of an input power interruption or outage. Furthermore, since current is not passing through capacitor 126, capacitor 126 stays cold, which increases the lifespan of capacitor 126 and decreases the cost associated with power supply device 100.

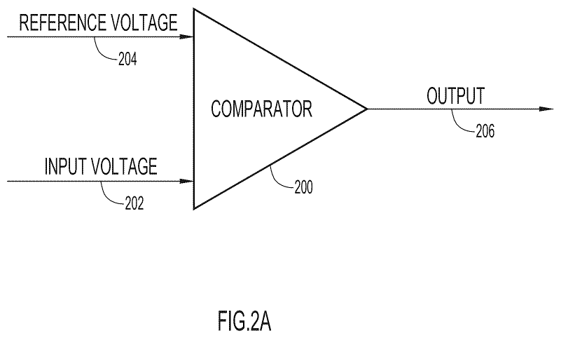

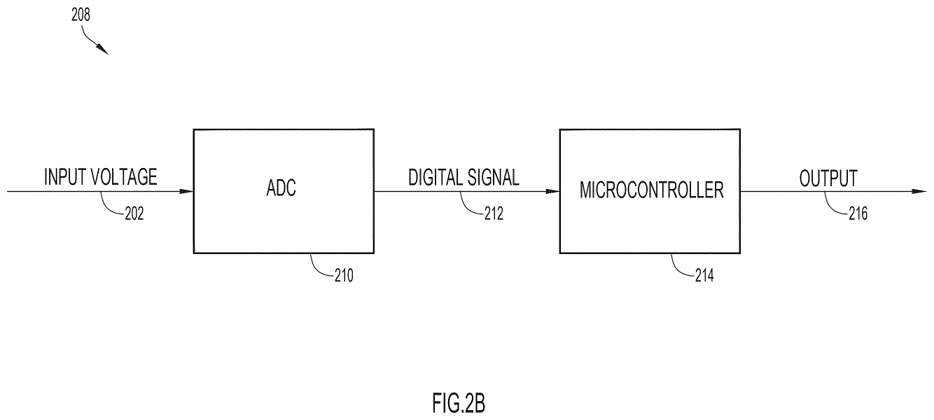

After capacitor 126 is fully charged (e.g., in a few seconds), according to techniques described herein, if input power is lost, the loss of input power is detected instantly by the input DC loss detector 122. When the loss of input power is detected, power supply device 100 provides an early warning signal for the load system/powered device to shut down in a controlled manner so that operation of the powered device will be fully recoverable when the input power is restored. In addition, the output of DC loss detector 122 is transmitted to isolated DC-to-DC converter 128 so that, when DC loss detector 122 determines that there is a loss of power, the isolated DC-to-DC converter 128 starts to convert the DC power held on the capacitor 126 into a DC output and feeds the DC output toward the downstream system/powered device to power the loads for a required hold up time (e.g., 20 mS). The input DC loss detector 122 may receive an input voltage reading and determine whether there is a loss of input power based on the input voltage reading. As described further below, with respect to FIGS. 2A and 2B, input DC loss detector 122 may be implemented in several ways and may be comprised of different elements (e.g., an analog-to-digital converter, a comparator, etc.).

As described above, techniques described herein remove the need for capacitor voltage derating and increase the holdup voltage of the capacitor 126 compared to that of capacitor 106. Therefore, by locating the capacitor in the energy holdup circuit 120 instead of in the main input current circuit 112, the energy storage per volume increases. This makes the power density of the power supply device that includes energy holdup circuit 120 greater than the power density of a power supply device in which the energy storing capacitor is located in the main input current circuit 112, as shown in the following equation:

$$E = \frac{1}{2} C {V}^{2} ,$$

in which E is the energy storage, C is the capacitance, and V is the voltage across the capacitor.

In a situation in which C is the same value for capacitor 106 (in a power supply device including just the main input current circuit 112) and the capacitor 126 (in a power supply device that includes the energy holdup circuit 120), and V² is not derated for capacitor 126 compared to a 80% derated V² for capacitor 106, moving the energy holding capacitor from the main input current circuit 112 to the energy holdup circuit 120 increases the energy storage by 1.56 times (V²/(0.8×V)²=1.56). Therefore, utilizing a power supply device 100 that includes energy storing capacitors in the energy holdup circuit 120 provides a 56% increase in energy storage compared to a traditional power supply unit that includes the energy storing capacitors in the main input current circuit 112.

To reiterate, according to the techniques described herein, the energy storing capacitor is moved so that it is no longer inside the main input current loop. In particular, in the example illustrated in FIG. 1, capacitor 106 is removed from main input current circuit 112 and capacitor 126 is added to energy holdup circuit 120. Therefore, according to the embodiments described herein, during normal operations, no current passes through the bulk capacitor (e.g., capacitor 126), there is no need for capacitor voltage derating, and the ESR associated with the capacitor is greatly reduced or eliminated. In the power supply device 100 that includes energy holdup circuit 120, the capacitor 126 is not in use unless a rare power loss situation occurs. Therefore, the capacitor 126 can stay cold and does not consume any power in normal situations, which provides energy and cost savings.

Reference is now made to FIGS. 2A and 2B. FIGS. 2A and 2B are diagrams that illustrate portions of two examples embodiments of the input DC loss detector 122. FIGS. 2A and 2B illustrate portions of circuits and any additional components of the circuits that may exist are not shown for the sake of brevity.

FIG. 2A illustrates an example in which input DC loss detector 122 uses a comparator 200 to determine whether input power has been lost or interrupted. Comparator 200 may receive input voltage 202 and compare the input to a reference voltage 204 or threshold level. If the input voltage 202 is greater than the reference voltage 204, comparator 200 outputs an output 206 of 1, which indicates that there is no power loss. If the reference voltage 204 is greater than the input voltage 202, the output 206 is 0, which indicates that there is a power loss. The output 206 may be transmitted to isolated DC-to-DC converter 128 so when there is a loss of power, the isolated DC-to-DC converter 128 may convert the DC power held on the capacitor 126 into a DC output for transmission to the powered device to power the load for a required hold up time.

FIG. 2B illustrates an example in which input DC loss detector 122 uses a circuit 208 that comprises an analog-to-digital converter (ADC) 210 and a microcontroller 214 to determine whether there has been a loss or interruption in input power. In this example, ADC 210 may receive input voltage 202 and convert the analog input voltage signal to a digital signal 212. Digital signal 212 is transmitted to a microcontroller 214 (e.g., a microcontroller 214 associated with power supply device 100) and, based on the digital signal 212, the microcontroller 214 may determine whether the power supply has been lost or interrupted. Microcontroller 214 transmits output 216 indicating whether the input power has been lost or interrupted. In some embodiments, circuit 208 may include additional components, such as a resistor circuit, to ensure that a sudden change in input voltage is not considered a power loss. The output 216 may be transmitted to isolated DC-to-DC converter 128.

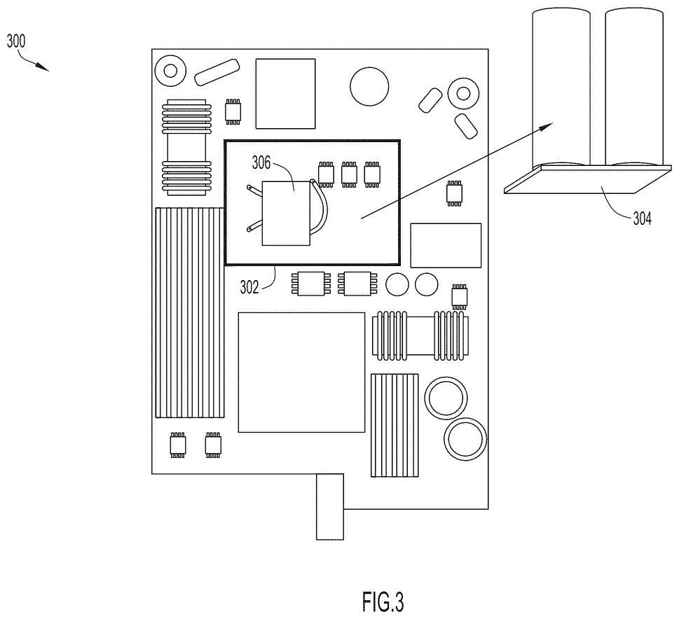

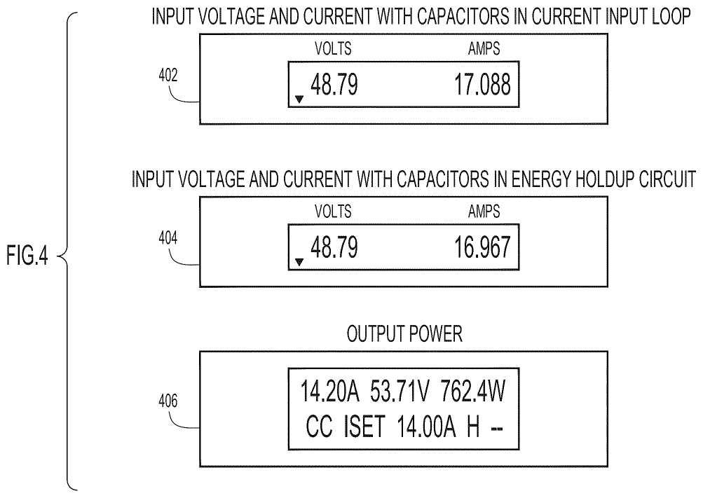

Reference is now made to FIG. 3. FIG. 3 illustrates an example system 300 in which a typical DC power source unit or device is modified to remove the bulk capacitors from the main DC input current loop and place bulk capacitors outside of the main DC input current loop, as illustrated in FIG. 1. In the example illustrated in FIG. 3, the original bulk capacitors 304 (i.e., before the modification) are three 820 uF/100V capacitors. Their total capacitance is 820×3=2460 uF and previously occupied about 20% of the space on the circuit board, as shown by box 302. In the example illustrated in FIG. 3, the original bulk capacitors 304 are removed and replaced with smaller 50 uF ceramic capacitors 306 that occupy a smaller space on the circuit board. Measurements (e.g., input voltage, input current, output power, etc.) are taken before and after the bulk capacitor replacement. The measurement results are shown in FIG. 4.

Reference is now made to FIG. 4. FIG. 4 illustrates results of the measurements performed before and after replacing bulk capacitors in a main DC input current loop of a circuit with smaller bulk capacitors in an energy holdup circuit connected to the main DC input current loop.

As illustrated at 406 of FIG. 4, the output power is the same (e.g., 762.4 W) regardless of the location of the bulk capacitors because the electronic load/powered device drains the same amount of power when the bulk capacitors are in either location. In addition, the input DC source provides the same input voltage of 48.79V. Although the input voltage stays the same, the input current changes with the relocation of the capacitors. When the bulk capacitors are located in the main input current circuit, as shown at 402, the input current is 17.038 A and when the bulk capacitors are moved from the main input current circuit 112 to the energy holdup circuit 120, as shown in 404, the input current is 16.967 A.

The power savings in this typical DC power source unit case can be calculated as follows:

$$Power savings = \frac{48.79 \times 17.038 - 48.79 \times 16.967}{762.4 W} = 0.4544 \%$$

Therefore, by moving the capacitors from the main input current circuit to the energy holdup circuit, a 0.45% efficiency improvement may be achieved while using smaller capacitors that take up less space on the circuit board. The above results are conservative because the inrush current limiting circuit, which consumes a little bit more power, was not removed when the bulk capacitors were removed. Additional power savings may be achieved by removing the inrush current limiting circuit, such as inrush current limiting circuit 102 in FIG. 1.

Additionally, by increasing the DC input boost voltage, the DC-to-DC stage has a higher input voltage, which means a lower input current and translates to less R I² transformer loss. This further increases efficiency of the power source device, which is not included in the 0.45% efficiency improvement shown.

In summary, techniques described herein move energy holding bulk capacitors away from the main input current loop to an energy holdup circuit connected to the main input current loop to store energy to provide power to downstream systems for a certain period of holdup time. When the capacitors are located in the energy holdup circuit, the ESR associated with the capacitors is decreased or eliminated and derating of the capacitor is unnecessary. As a result, as described above, energy efficiency and power density increase, size and cost can be reduced, and holdup time becomes longer.

Preliminary test results show an immediate 0.45% efficiency improvement and an over 50% theoretical holdup energy storage improvement from moving a capacitor bank from a main input current circuit to an energy holdup circuit connected to the main input current circuit. Additionally, these techniques eliminate the need of inrush current limiting circuits, which will remove some circuits and free up additional space to further improve power efficiency, holdup time, and cost.

As a result of these techniques, DC input power supply unit energy efficiency, holdup energy storage, and power density are increased, while size and cost are reduced. For example, for a 30 kW rack, energy saving will be 135 W (i.e., 30,000 W×0.45%=135 W). For every watt of wasted heat, a datacenter needs to spend one watt of power for cooling. Therefore, implementing the techniques described herein can bring 270 W (135×2=270 W) of power savings per rack for customers.

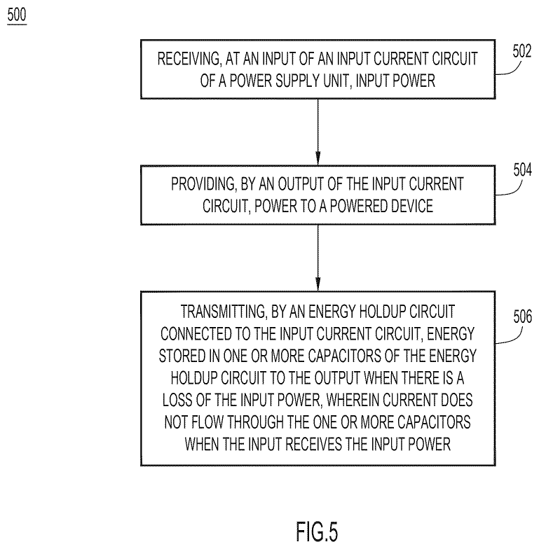

Reference is now made to FIG. 5. FIG. 5 is a flow chart of a method 500 of transmitting energy from one or more capacitors of an energy holdup circuit connected to an input current circuit to an output when there is a loss of input power.

At 502, the method 500 involves receiving input power at an input of an input current circuit of a power supply unit. At 504, the method includes providing power to a powered device by an output of the input current circuit. At 506, the method involves transmitting energy stored in one or more capacitors of an energy holdup circuit connected to the input current circuit to the output when there is a loss of the input power. Current does not flow through the one or more capacitors when the input receives the input power.

In summary, techniques described herein improve power efficiency and holdup time of power supply units by removing energy holding capacitors from a main input current loop and installing energy holding capacitors in an energy holdup loop connected to the main input current loop. According to embodiments described herein, current does not pass through the energy holding capacitors located in the energy holdup loop. As a result, ESR is reduced or eliminated and capacitor derating is not needed, which increases energy efficiency and holdup time while allowing smalling capacitors to be used. In addition, the energy storing capacitors in the energy holdup loop are charged slowly through a large resistor, which reduces inrush current and the need for inrush current limiting circuits. Furthermore, because current does not flow through the energy holding capacitors, the capacitors remain cold and a lifetime of the capacitors is increased. Therefore, moving the capacitors from the main input current loop to the energy holdup loop of the power supply unit improves power efficiency and holdup time while reducing costs and size associated with the power supply unit.

In one form, a power supply device is provided that includes an input current circuit including: an input for receiving input power, and an output for providing power to a powered device; and an energy holdup circuit connected to the input current circuit, the energy holdup circuit including one or more capacitors for storing energy, wherein the energy holdup circuit is configured to couple energy stored in the one or more capacitors to the output when there is a loss of the input power, and to not direct current through the one or more capacitors when the input receives the input power.

In one example, the energy holdup circuit further includes a current limiting resistor to limit current for charging the one or more capacitors. In another example, the energy holdup circuit includes an input power loss detector to detect when there is a loss of the input power. In another example, the input power loss detector includes a comparator to output an indication of whether an input voltage is below a threshold level. In another example, the input power loss detector includes an analog-to-digital converter to output a value indicative of an input voltage.

In another example, the energy holdup circuit further includes an isolated direct current (DC)-to-DC converter configured to, when there is a loss of the input power, convert DC power stored on the one or more capacitors into a DC output and transmit the DC output to the output for providing power to the powered device. In another example, the one or more capacitors are configured to store an amount of the energy based on a voltage rating of the one or more capacitors without voltage derating. In another example, a number of the one or more capacitors included in the energy holdup circuit is configurable based on a power requirement of the powered device. In another example, when there is a loss of the input power, the output is configured to provide an indication to the powered device to shut down.

In another form, a method is provided that includes: receiving, at an input of an input current circuit of a power supply unit, input power; providing, by an output of the input current circuit, power to a powered device; and transmitting, by an energy holdup circuit connected to the input current circuit, energy stored in one or more capacitors of the energy holdup circuit to the output when there is a loss of the input power, wherein current does not flow through the one or more capacitors when the input receives the input power.

In one example, the further includes charging the one or more capacitors through a resistor. In another example, the method further includes detecting, by an input power loss detector of the energy holdup circuit, when there is a loss of the input power. In another example, transmitting the energy stored in the one or more capacitors to the output when there is a loss of the input power further includes: converting, by an isolated direct current (DC)-to-DC converter of the energy holdup circuit, DC power stored on the one or more capacitors into a DC output when there is a loss of the input power; and transmitting, by the isolated DC-to-DC converter, the DC output to the output for providing power to the powered device. In another example, the method further includes storing, by the one or more capacitors, an amount of the energy based on a voltage rating of the one or more capacitors without voltage derating. In another example, the method further includes providing an indication to the powered device to shut down when there is a loss of the input power.

In yet another form, a device is provided. The device includes an energy holdup circuit connected to an input current circuit, the energy holdup circuit including: one or more capacitors configured to store energy, wherein current does not flow through the one or more capacitors when the input current circuit receives input power, and an isolated direct current (DC)-to-DC converter configured to couple the energy stored in the one or more capacitors to an output of the input current circuit when there is a loss of the input power.

In one example, the energy holdup circuit further includes an input power loss detector configured to detect when there is a loss of the input power. In another example, the one or more capacitors are configured to store an amount of the energy based on a voltage rating of the one or more capacitors without voltage derating. In another example, a number of the one or more capacitors included in the energy holdup circuit is configurable based on a power requirement of a load that is powered by the device. In another example, when there is a loss of the input power, the device is configured to provide an indication to shut down to a load that is powered by the device.

### Variations and Implementations

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A power supply device comprising:
an input current circuit comprising:
an input for receiving input power, and
an output for providing power to a powered device; and
an energy holdup circuit connected to the input current circuit, the energy holdup circuit including one or more capacitors for storing energy, wherein the energy holdup circuit is configured to couple energy stored in the one or more capacitors to the output when there is a loss of the input power, and to not direct current through the one or more capacitors when the input receives the input power.

2. The power supply device of claim 1, wherein the energy holdup circuit further comprises a current limiting resistor to limit current for charging the one or more capacitors.

3. The power supply device of claim 1, wherein the energy holdup circuit includes an input power loss detector to detect when there is a loss of the input power.

4. The power supply device of claim 3, wherein the input power loss detector includes a comparator to output an indication of whether an input voltage is below a threshold level.

5. The power supply device of claim 3, wherein the input power loss detector includes an analog-to-digital converter to output a value indicative of an input voltage.

6. The power supply device of claim 1, wherein the energy holdup circuit further comprises an isolated direct current (DC)-to-DC converter configured to, when there is a loss of the input power, convert DC power stored on the one or more capacitors into a DC output and transmit the DC output to the output for providing power to the powered device.

7. The power supply device of claim 1, wherein the one or more capacitors are configured to store an amount of the energy based on a voltage rating of the one or more capacitors without voltage derating.

8. The power supply device of claim 1, wherein a number of the one or more capacitors included in the energy holdup circuit is configurable based on a power requirement of the powered device.

9. The power supply device of claim 1, wherein, when there is a loss of the input power, the output is configured to provide an indication to the powered device to shut down.

10. A method comprising:
receiving, at an input of an input current circuit of a power supply unit, input power;
providing, by an output of the input current circuit, power to a powered device; and
transmitting, by an energy holdup circuit connected to the input current circuit, energy stored in one or more capacitors of the energy holdup circuit to the output when there is a loss of the input power, wherein current does not flow through the one or more capacitors when the input receives the input power.

11. The method of claim 10, further comprising:
charging the one or more capacitors through a resistor.

12. The method of claim 10, further comprising:
detecting, by an input power loss detector of the energy holdup circuit, when there is a loss of the input power.

13. The method of claim 10, wherein transmitting the energy stored in the one or more capacitors to the output when there is a loss of the input power further comprises:
converting, by an isolated direct current (DC)-to-DC converter of the energy holdup circuit, DC power stored on the one or more capacitors into a DC output when there is a loss of the input power; and
transmitting, by the isolated DC-to-DC converter, the DC output to the output for providing power to the powered device.

14. The method of claim 10, further comprising:
storing, by the one or more capacitors, an amount of the energy based on a voltage rating of the one or more capacitors without voltage derating.

15. The method of claim 10, further comprising:
providing an indication to the powered device to shut down when there is a loss of the input power.

16. A device comprising:
an energy holdup circuit connected to an input current circuit, the energy holdup circuit including:
one or more capacitors configured to store energy, wherein current does not flow through the one or more capacitors when the input current circuit receives input power, and
an isolated direct current (DC)-to-DC converter configured to couple the energy stored in the one or more capacitors to an output of the input current circuit when there is a loss of the input power.

17. The device of claim 16, wherein the energy holdup circuit further includes an input power loss detector configured to detect when there is a loss of the input power.

18. The device of claim 16, wherein the one or more capacitors are configured to store an amount of the energy based on a voltage rating of the one or more capacitors without voltage derating.

19. The device of claim 16, wherein a number of the one or more capacitors included in the energy holdup circuit is configurable based on a power requirement of a load that is powered by the device.

20. The device of claim 16, wherein, when there is a loss of the input power, the device is configured to provide an indication to shut down to a load that is powered by the device.
